(19) United States
(12) Patent Application Publication
(10) Pub. No.: US 2024/0128028 A1
(43) Pub. Date: Apr. 18, 2024

(54) SOLID ELECTROLYTIC CAPACITOR AND METHOD OF MANUFACTURING SOLID ELECTROLYTIC CAPACITOR

(71) Applicant: Murata Manufacturing Co., Ltd., Nagaokakyo-shi (JP)

(72) Inventor: Takeshi FURUKAWA, Nagaokakyo-shi (JP)

(21) Appl. No.: 18/396,233

(22) Filed: Dec. 26, 2023

Related U.S. Application Data
(63) Continuation of application No. PCT/JP2022/024098, filed on Jun. 16, 2022.

(30) Foreign Application Priority Data
Jun. 29, 2021 (JP) 2021-107735

(51) Int. Cl. H01G 9/10; H01G 9/028; H01G 9/048; H01G 9/15

(52) U.S. Cl. CPC H01G 9/10; H01G 9/028; H01G 9/048; H01G 9/15

(57) ABSTRACT

A solid electrolytic capacitor that includes: an anode plate made of a valve metal; a porous layer on at least one of principal surface of the anode plate; a dielectric layer on a surface of the porous layer; a cathode layer that includes a solid electrolyte layer on the dielectric layer, the cathode layer including two or more cathode portions; a first insulating layer that surrounds at least one of the cathode portions as viewed in a thickness direction of the solid electrolytic capacitor, wherein a material of the first insulating layer fills a portion of the porous layer and is also present on a surface of the filled portion of the porous layer; and a first piercing section that pierces through both of the porous layer and the first insulating layer in the thickness direction.

### CROSS REFERENCE TO RELATED APPLICATIONS

The present application is a continuation of International application No. PCT/JP2022/024098, filed Jun. 16, 2022, which claims priority to Japanese Patent Application No. 2021-107735, filed Jun. 29, 2021, the entire contents of each of which are incorporated herein by reference.

### TECHNICAL FIELD

The present invention relates to a solid electrolytic capacitor and also to a method of manufacturing the solid electrolytic capacitor.

### BACKGROUND ART

A solid electrolytic capacitor includes an anode plate that is made of a valve metal, such as aluminum, and has a porous layer and a dielectric layer formed on the surface of the porous layer. The solid electrolytic capacitor also includes a cathode layer having a solid electrolyte layer formed on the surface of the dielectric layer.

In order to obtain a high-performance solid electrolytic capacitor, it is important to provide reliable electrical insulation between the anode plate (anode portion) on which the solid electrolyte layer is not formed and the cathode layer (cathode portion) on which the solid electrolyte layer is formed.

Japanese Patent No. 4623404 (hereinafter “Patent Document 1”) discloses a method of manufacturing a solid electrolytic capacitor that includes a dielectric film and a valve-metal member on which a solid electrolyte layer is formed at a desired position. The method includes a step of applying a masking material solution that permeates a portion of the dielectric film and that forms a masking layer also on the permeated portion of the dielectric film.

### SUMMARY OF THE INVENTION

According to the method of manufacturing the solid electrolytic capacitor described in Patent Document 1, the masking material permeates a portion of the dielectric film and the masking layer is formed also on the permeated portion of the dielectric film, which prevents the solid electrolyte from entering the permeated portion of the dielectric film. In addition, the masking layer further masks the permeated portion. This structure can provide reliable insulation between the anode portion and the cathode portion.

According to Patent Document 1, it is difficult to apply the masking material in such a manner as to draw a uniform line along the entire circumference of a substrate in the case of using methods 1) to 3) below.

1) A method in which the masking material is trickled directly onto the surface of the substrate (made of a surface-treated aluminum foil using chemical conversion), for example, using a dispenser, so as to form a string-like line thereon.

2) A method in which the masking material is applied onto the surface of the surface-treated aluminum foil using a thin stick, such as a bamboo stick.

3) A method in which the masking material is applied onto the surface-treated aluminum foil using screen printing.

Patent Document 1 also describes that the masking material was successfully applied onto the substrate in such a manner as to draw a uniform line along the entire circumference of a desired region using the following steps 1) to 5).

1) Multiple strips (substrates) of a surface-treated foil are attached, in a cantilever manner, to a linearly movable base (metallic guide).

2) A disk-like roll that rotates is disposed such that the smooth circumferential surface (application surface) of the roll is in contact, at a constant pressure, with the back surface (bottom surface) of each substrate attached to the metallic guide.

3) The masking material is supplied, in a closed system, to the application surface of the rotating roll. In other words, a solution containing the masking material is stored in a closed container, and the solution is supplied, for example, through a resin tube and a needle, using a proportional liquid feeder, such as a proportional- and continuous-flow dispenser with little pulsation.

4) The solution containing the masking material is applied uniformly to the circumferential application surface of the rotating roll. The masking material is transferred to the bottom and side surfaces of each surface-treated foil substrate by pressing the rotating roll against the substrate while the moving speed of the metallic guide and the rotational speed of the roll are adjusted.

5) A cleaning device to clean the application surface of the roll is provided, and the cleaning device removes the masking material remaining on the application surface of the roll after the roll with the solution of the masking material applied thereto comes into contact with each surface-treated foil substrate and before a fresh solution is applied to the roll again.

Patent Document 1 describes a method of applying the masking material to strips, which are made of the surface-treated foil and separated and shaped as capacitor elements in advance. The strips are attached to the metallic guide, and the masking material is applied by roller transfer. However, in the case of manufacturing an arrayed solid electrolytic capacitor in which a cathode layer is divided into two or more cathode portions, the roller transfer is not suitable to apply the masking material in order to separate multiple capacitor elements from each other. Moreover, in the case of applying the masking material discontinuously, which may be required depending on the shape of the capacitor element, the roller transfer is difficult to carry out discontinuous application of the masking material.

Accordingly, an object of the present invention is to provide a solid electrolytic capacitor in which a cathode layer is divided into two or more cathode portions and the cathode portions are reliably insulated from corresponding anode portions. Another object of the present invention is to provide a method of manufacturing the solid electrolytic capacitor in which the cathode layer is divided into two or more cathode portions and the cathode portions are reliably insulated from the corresponding anode portions.

According to an aspect of the present invention, a solid electrolytic capacitor includes: an anode plate made of a valve metal; a porous layer on at least one principal surface of the anode plate; a dielectric layer on the porous layer; a cathode layer including a solid electrolyte layer on the dielectric layer, the cathode layer including two or more cathode portions; a first insulating layer that surrounds at least one of the cathode portions as viewed in a thickness direction of the solid electrolytic capacitor, wherein a material of the first insulating layer fills a portion of the porous layer and is also present on a surface of the filled portion of the porous layer; and a first piercing section that pierces through both of the porous layer and the first insulating layer in the thickness direction.

According to an aspect of the present invention, a method of manufacturing a solid electrolytic capacitor includes: providing an anode plate made of a valve metal; forming a porous layer on at least one principal surface of the anode plate; forming a dielectric layer on the porous layer; forming a cathode layer that includes a solid electrolyte layer formed on a surface of a dielectric layer; dividing the cathode layer into two or more cathode portions; forming a first insulating layer that divides the anode plate into two or more element regions and surrounds at least one of the element regions as viewed in a thickness direction of the anode plate, wherein each of the two or more element regions includes one of the two or more cathode portions, and a material of the insulating layer fills a portion of the porous layer and is also present on a surface of the filled portion of the porous layer; and forming a first piercing section that pierces through both of the porous layer and the first insulating layer in the thickness direction.

Accordingly, the present invention can provide the solid electrolytic capacitor in which the cathode layer is divided into two or more cathode portions and the cathode portions are reliably insulated from the corresponding anode portions. In addition, the present invention can provide the method of manufacturing the solid electrolytic capacitor in which the cathode layer is divided into two or more cathode portions and the cathode portions are reliably insulated from the corresponding anode portions.

### BRIEF DESCRIPTION OF THE DRAWINGS

FIG. 1 is a perspective view schematically illustrating an example of a solid electrolytic capacitor according to the present invention.

FIG. 2 is a cross-sectional view illustrating the solid electrolytic capacitor of FIG. 1, which is taken along line II-II.

FIG. 3 is a cross-sectional view illustrating the solid electrolytic capacitor of FIG. 1, which is taken along line III-III.

FIG. 4 is a perspective view schematically illustrating a capacitor layer included in the solid electrolytic capacitor of FIG. 1.

FIG. 5 is a cross-sectional view illustrating the capacitor layer of FIG. 4, which is taken along line V-V.

FIG. 6 is a cross-sectional view illustrating the capacitor layer of FIG. 4, which is taken along line VI-VI.

FIG. 7 is a cross-sectional view schematically illustrating a first through-hole conductor and the vicinity thereof according to another example of the solid electrolytic capacitor of the present invention.

FIG. 8 is a cross-sectional view schematically illustrating a second through-hole conductor and its vicinity of the solid electrolytic capacitor of FIG. 7.

FIG. 9 is a perspective view schematically illustrating an example of a step of forming an insulating layer on an anode plate.

FIG. 10 is a perspective view schematically illustrating an example of a step of forming a cathode layer.

FIG. 11 is a perspective view schematically illustrating an example of a step of forming a first piercing section.

FIG. 12 is a perspective view schematically illustrating an example of a step of forming second through-holes, which is part of a step of forming a second piercing section.

FIG. 13 is a perspective view schematically illustrating an example of a step of forming a sealing layer.

FIG. 14 is a perspective view schematically illustrating an example of a step of forming first through-holes, which is part of the step of forming the second piercing section.

FIG. 15 is a perspective view schematically illustrating an example of a step of forming through-hole conductors.

### DETAILED DESCRIPTION OF THE PREFERRED EMBODIMENTS

The following describes a solid electrolytic capacitor of the present invention and a method of manufacturing the solid electrolytic capacitor.

The present invention, however, is not limited to the configurations described below but can be applied in an altered manner within the scope of the present invention. Note that two or more of the individual configurations of the present invention can be combined, and such a combination is deemed to be included in the present invention.

[Solid Electrolytic Capacitor]

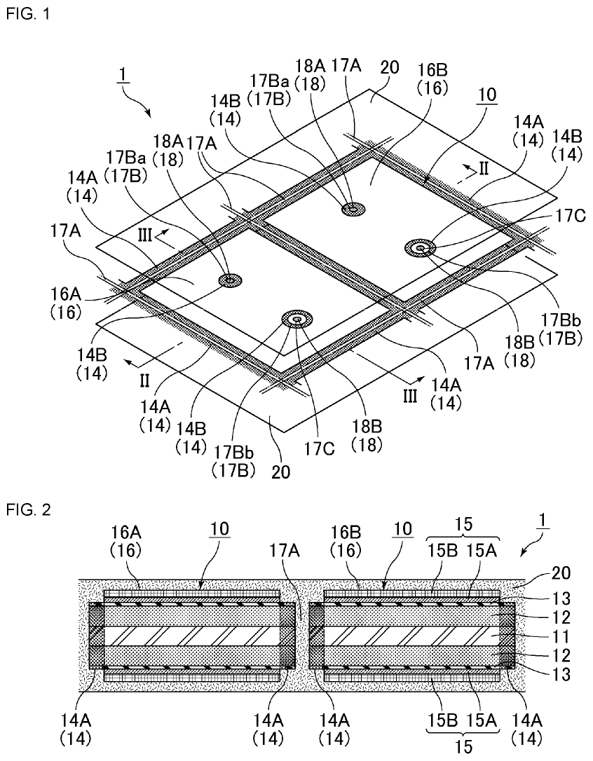

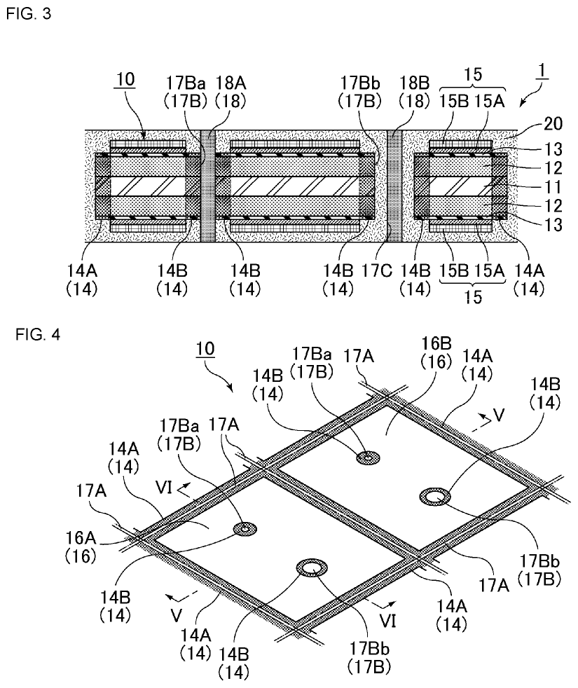

FIG. 1 is a perspective view schematically illustrating an example of a solid electrolytic capacitor according to the present invention. FIG. 2 is a cross-sectional view illustrating the solid electrolytic capacitor of FIG. 1, which is taken along line II-II. FIG. 3 is a cross-sectional view illustrating the solid electrolytic capacitor of FIG. 1, which is taken along line III-III.

A solid electrolytic capacitor 1 illustrated in FIGS. 1, 2, and 3 includes a capacitor layer 10. As illustrated in FIGS. 1, 2, and 3, the solid electrolytic capacitor 1 may also include a sealing layer 20.

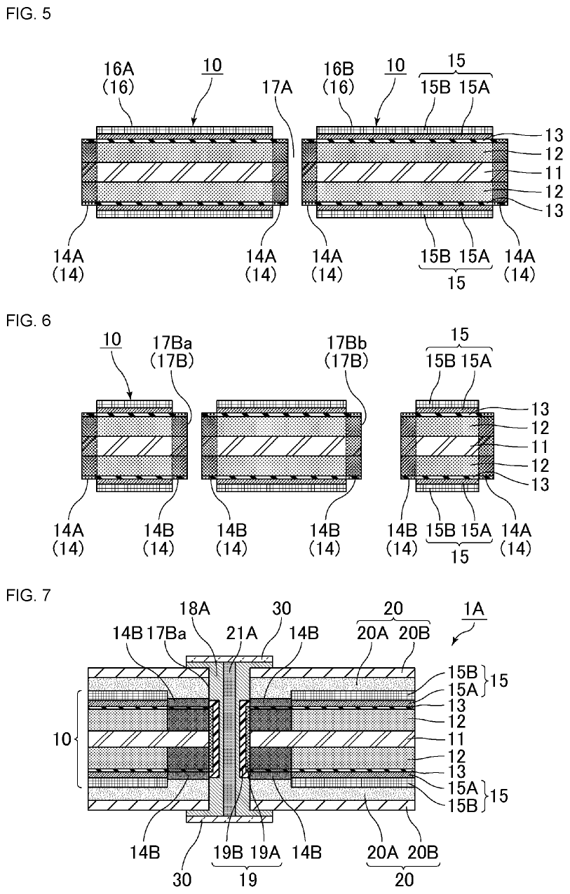

FIG. 4 is a perspective view schematically illustrating a capacitor layer included in the solid electrolytic capacitor of FIG. 1. FIG. 5 is a cross-sectional view illustrating the capacitor layer of FIG. 4, which is taken along line V-V. FIG. 6 is a cross-sectional view illustrating the capacitor layer of FIG. 4, which is taken along line VI-VI.

In the solid electrolytic capacitor 1 illustrated in FIGS. 1, 2, and 3, the capacitor layer 10 includes, as illustrated in FIGS. 4, 5, and 6, an anode plate 11, a porous layer 12, a dielectric layer 13, an insulating layer 14, and a cathode layer 15. The porous layer 12 is formed on at least one of the principal surfaces of the anode plate 11, and the dielectric layer 13 is formed on the surface of the porous layer 12. The insulating layer 14 is formed so as to fill part of the porous layer 12 and so as to be also present on the surface of the filled part of the porous layer 12. The cathode layer 15 is formed on the surface of the dielectric layer 13. For example, the cathode layer 15 includes a solid electrolyte layer 15A formed on the surface of the dielectric layer 13 and a conductive layer 15B formed on the surface of the solid electrolyte layer 15A. Note that the solid electrolytic capacitor 1 does not need to include the sealing layer 20 and may include the capacitor layer 10 only.

The cathode layer 15 is divided into two or more cathode portions 16. FIGS. 1, 2, 4, and 5 illustrate only one adjacent pair of the cathode portions 16, in other words, a first cathode portion 16A and a second cathode portion 16B.

The insulating layer 14 includes a first insulating layer 14A that surrounds at least one of the cathode portions 16 as viewed in the thickness direction. In FIGS. 1 and 4, the first insulating layer 14A is formed so as to surround the first cathode portion 16A and the second cathode portion 16B.

The solid electrolytic capacitor 1 or the capacitor layer 10 has a first piercing section 17A that pierces through both of the porous layer 12 and the first insulating layer 14A in the thickness direction. As illustrated in FIGS. 2 and 5, the first piercing section 17A may pierce through the anode plate 11 in the thickness direction. In other words, the first piercing section 17A may pierce through the capacitor layer 10 in the thickness direction.

The anode plate 11 may be separated between at least one adjacent pair of the cathode portions 16, in other words, between the first cathode portion 16A and the second cathode portion 16B. More specifically, the anode plate 11 may be separated physically or may be separated electrically between at least one adjacent pair of the cathode portions 16, in other words, between the first cathode portion 16A and the second cathode portion 16B. For example, as illustrated in FIGS. 2 and 5, the anode plate 11 may be separated between the first cathode portion 16A and the second cathode portion 16B in such a manner that the first piercing section 17A pierces through the anode plate 11 in the thickness direction.

The insulating layer 14 may also include a second insulating layer 14B that is formed within a cathode portion 16 surrounded by the first insulating layer 14A. In such a case, the second insulating layer 14B may be formed within at least one of the cathode portions 16. In FIGS. 1 and 4, the second insulating layer 14B is formed in each of the first cathode portion 16A and the second cathode portion 16B.

In the case of the insulating layer 14 including the second insulating layer 14B, a second piercing section 17B may be formed so as to pierce through both of the porous layer 12 and the second insulating layer 14B in the thickness direction. As illustrated in FIGS. 3 and 6, the second piercing section 17B may pierce through the anode plate 11 in the thickness direction. In other words, the second piercing section 17B may pierce through the capacitor layer 10 in the thickness direction.

It is preferable that a through-hole conductor 18 be formed inside the second piercing section 17B so as to extend in the thickness direction. As illustrated in FIG. 3, the through-hole conductor 18 is preferably formed so as to pierce through the capacitor layer 10 and the sealing layer 20 in the thickness direction.

As illustrated in FIGS. 1, 3, 4, and 6, a first through-hole 17Ba and a second through-hole 17Bb may be formed as part of the second piercing section 17B. The second through-hole 17Bb has a larger hole diameter than the first through-hole 17Ba.

A first through-hole conductor 18A is preferably formed inside the first through-hole 17Ba so as to extend in the thickness direction. In FIG. 3, the first through-hole conductor 18A is formed so as to pierce through the capacitor layer 10 and the sealing layer 20 in the thickness direction. As illustrated in FIG. 3, the first through-hole conductor 18A is preferably connected electrically to the anode plate 11 at the wall of the first through-hole 17Ba. In FIG. 3, the first through-hole conductor 18A is formed so as to fill the first through-hole 17Ba. It is sufficient that the first through-hole conductor 18A is formed at least on the wall surface of the first through-hole 17Ba.

A second through-hole conductor 18B is preferably formed inside the second through-hole 17Bb so as to extend in the thickness direction. In FIG. 3, the second through-hole conductor 18B is formed so as to pierce through the capacitor layer 10 and the sealing layer 20 in the thickness direction. As illustrated in FIG. 3, the second through-hole conductor 18B is preferably insulated electrically from the anode plate 11 at the wall of the second through-hole 17Bb. In FIG. 3, the second through-hole conductor 18B is formed so as to fill a third through-hole 17C having a hole diameter smaller than the second through-hole 17Bb. It is sufficient that the second through-hole conductor 18B is formed at least on the wall surface of the third through-hole 17C. The diameter of the third through-hole 17C may be the same as, or smaller or larger than, the diameter of the first through-hole 17Ba.

The anode plate 11 is made of a valve metal that exhibits so-called valve action. An example of the valve metal is a metal such as aluminum, tantalum, niobium, titanium, or zirconium, or an alloy containing at least one of these. It is preferable to use aluminum or an aluminum alloy among these.

The shape of the anode plate 11 is preferably a tabular plate or more preferably a foil. The anode plate 11 may have the porous layer 12 on at least one of the principal surfaces or may have the porous layers 12 on both principal surfaces. The porous layer 12 is preferably an etched layer of the anode plate 11 formed on the surface thereof.

The thickness of the anode plate 11 before etching is preferably 60 μm to 200 μm. The thickness of the unetched core of the anode plate 11 remaining after etching is preferably 15 μm to 70 μm. The thickness of the porous layer 12 is determined in accordance with the required level of voltage to withstand and the required electrostatic capacity. The total thickness of the porous layers 12 on both sides is preferably 10 μm to 180 μm.

The pore size of the porous layer 12 is preferably 10 nm to 600 nm. Note that the pore size of the porous layer 12 is measured using a mercury porosimeter and expressed as median diameter D50. The pore size of the porous layer 12 can be controlled by adjusting various etching conditions.

The surface of the dielectric layer 13 is porous and has fine irregularities that reflect the surface condition of the porous layer 12. The dielectric layer 13 is preferably made of an oxide film of the above-described valve metal. For example, in the case of the anode plate 11 being made of an aluminum foil, the dielectric layer of the oxide film can be formed by performing anodic oxidation treatment (otherwise referred to as a “chemical conversion treatment”) on the surface of the aluminum foil in an aqueous solution of, for example, ammonium adipate.

The thickness of the dielectric layer 13 is determined in accordance with the required level of voltage to withstand and the required electrostatic capacity. The thickness of the dielectric layer 13 is preferably 10 nm to 100 nm.

The insulating layer 14, which includes, for example, the first insulating layer 14A and the second insulating layer 14B, is preferably made of resin. Examples of the resin for the insulating layer include insulating resins, such as polyphenyl sulfone resin, polyether sulfone resin, cyanate ester resin, fluororesin (such as tetrafluoroethylene or tetrafluoroethylene-perfluoroalkylvinylether copolymer), polyimide resin, polyamide imide resin, epoxy resin, and derivatives or precursors of these. The first insulating layer 14A and the second insulating layer 14B may be made of the same resin or may be made of different resins.

The insulating layer 14 may be made of the same resin as that of the sealing layer 20. The insulating layer 14 is preferably made of a resin material without containing any filler, which is different from the sealing layer 20, because an insulating layer 14 made of a resin material containing an inorganic filler may have negative influence on an effective part of the solid electrolytic capacitor.

The insulating layer 14 can be formed by applying a masking material, such as a composite containing an insulating resin, onto the porous layer 12, for example, by using a dispenser or using sponge transfer, screen printing, or ink-jet printing.

The thickness of the insulating layer 14 from the surface of the porous layer 12 is preferably 20 μm or less. The thickness of the insulating layer 14 from the surface of the porous layer 12 can be 0 μm but preferably 2 μm or greater.

The cathode layer 15 includes the solid electrolyte layer 15A formed on the surface of the dielectric layer 13. The cathode layer 15 further includes the conductive layer 15B formed on the surface of the solid electrolyte layer 15A.

Examples of the material of the solid electrolyte layer 15A include electroconductive polymers, such as polypyrroles, polythiophenes, or polyanilines. It is preferable to use a polythiophene among these. It is especially preferable to use poly(3,4-ethylenedioxythiophene) or otherwise called “PEDOT”. The above electroconductive polymer may contain a dopant, such as polystyrene sulfonate (PSS). Note that the solid electrolyte layer 15A preferably includes an inner layer that enters fine recesses of the dielectric layer 13 and an outer layer that covers the dielectric layer 13.

The thickness of the solid electrolyte layer 15A from the surface of the porous layer 12 is preferably 2 μm to 20 μm.

The solid electrolyte layer 15A can be obtained, for example, using a method of forming a polymerized film on the surface of the dielectric layer 13 in a processing solution containing monomers of 3,4-ethylenedioxythiophene, or a method of applying a polymer dispersion liquid containing, for example, poly(3,4-ethylenedioxythiophene) onto the surface of the dielectric layer 13 and subsequently drying the liquid.

The solid electrolyte layer 15A can be formed, for example, by using a dispenser or using sponge transfer, screen printing, or ink-jet printing and thereby applying the above processing solution or dispersion liquid onto predetermined regions on the dielectric layer 13.

The conductive layer 15B includes at least one of an electroconductive resin layer and a metal layer. The conductive layer 15B may include the electroconductive resin layer only or the metal layer only. The conductive layer 15B preferably covers the entire surface of the solid electrolyte layer 15A.

For example, the electroconductive resin layer is made of an electroconductive adhesive containing at least one conductive filler selected from the group consisting of silver filler, copper filler, nickel filler, and carbon filler.

For example, the metal layer can be a metal plating layer or a metal foil. The metal layer is preferably made of at least one metal selected from the group consisting of nickel, copper, silver, and an alloy containing one of these metals as a main ingredient. The term “main ingredient” refers to a chemical element of the highest weight percentage.

For example, the conductive layer 15B includes a carbon layer formed on the surface of the solid electrolyte layer 15A and a copper layer formed on the surface of the carbon layer.

The carbon layer serves to connect the copper layer to the solid electrolyte layer 15A electrically and mechanically. The carbon layer can be formed by applying a carbon paste onto predetermined regions on the solid electrolyte layer 15A, for example, by using a dispenser or using sponge transfer, screen printing, or ink-jet printing. Note that the carbon layer preferably remains in an undried and viscous state in the subsequent step of laminating the copper layer on the carbon layer. The thickness of the carbon layer is preferably 2 μm to 20 μm.

The copper layer can be formed by applying a copper paste onto the carbon layer, for example, by using a dispenser or using sponge transfer, spray application, screen printing, or ink-jet printing. The thickness of the copper layer is preferably 2 μm to 20 μm.

The number of the cathode portions 16, such as the first cathode portion 16A and the second cathode portion 16B, is not specifically limited but may be two or more. The cathode portions 16 may be disposed linearly or may be arrayed two-dimensionally. The cathode portions 16 may be arranged regularly or irregularly. As viewed in the thickness direction, in other words, as viewed in plan, the sizes and shapes of the cathode portions 16 may be the same or may be different partially or entirely. As viewed in the thickness direction, two or more types of the cathode portions 16 having different areas may be disposed.

As viewed in the thickness direction, some cathode portions 16 may have shapes other than a rectangle. As used herein, the term “rectangle” refers to a regular square or an oblong rectangle. For example, as viewed in plan, some cathode portions 16 may be shaped like a polygon, such as a triangle, a tetragon other than the rectangle, a pentagon, or a hexagon, or may be shaped so as to include a curved side, or shaped like a circle or an oval. In such a case, the cathode portions 16 may include two or more types with different shapes as viewed in plan. As viewed in plan, while some cathode portions 16 may have a non-rectangular shape, other cathode portions 16 may have a rectangular shape or a non-rectangular shape.

In the two or more cathode portions 16, all the cathode portions 16 may be surrounded by the first insulating layer 14A. Alternatively, some cathode portions 16 need not be surrounded by the first insulating layer 14A. When the cathode portions 16 are surrounded by the first insulating layer 14A, the cathode portions 16 may be surrounded entirely or may be surrounded only partially by the first insulating layer 14A.

It is preferable that the first piercing section 17A be formed so as to have a slit-like shape. The width of the first piercing section 17A is not specifically limited but may be preferably 15 μm or more, more preferably 30 μm or more, or even more preferably 50 μm or more. On the other hand, the width of the first piercing section 17A may be preferably 500 μm or less, more preferably 200 μm or less, or even more preferably 150 μm or less.

At least part of the first piercing section 17A may be disposed so as not to overlap the entire solid electrolytic capacitor 1. In this case, at least one cathode portion 16 may be present on an imaginary extension of the first piercing section 17A.

The first piercing section 17A may have a tapered portion of which the width becomes smaller in the thickness direction. In the case of the first piercing section 17A piercing through the capacitor layer 10 in the thickness direction, the tapered portion of the first piercing section 17A preferably does not reach the anode plate 11.

The second piercing section 17B is preferably through-holes, such as the first through-hole 17Ba or the second through-hole 17Bb. For example, the cross-sectional shape of the second piercing section 17B as viewed in the thickness direction is not specifically limited but may be a polygon such as a tetragon or may be a circle or an oval. Note that the hole diameter of the second piercing section 17B is defined as the diameter of the hole when the cross-sectional shape is the circle. When the cross-sectional shape is not the circle, the diameter of the hole is defined as a maximum length along a straight line passing through the center of the hole. The second piercing section 17B may have a tapered portion of which the hole diameter becomes smaller in the thickness direction.

The through-hole conductor 18, such as the first through-hole conductor 18A and the second through-hole conductor 18B, is formed so as to pierce through the capacitor layer 10 in the thickness direction. The through-hole conductor 18 may be formed at least on the wall surface of the through-hole. The wall surface of the through-hole is metallized with a low-resistance metal, such as copper, gold, or silver. The wall surface can be metallized, for example, using electroless copper plating or electrolytic copper plating from the viewpoint of easy processing. The formation of the through-hole conductor 18 is not limited to the metallization of the wall surface of the through-hole but may be carried out, for example, by filling a metal or a composite material of a metal and a resin in the through-hole.

The through-hole conductors 18 are classified into A) those for the anode of the capacitor, B) those for the cathode of the capacitor, and C) those for the I/O lines. Each through-hole conductor 18 for the anode of the capacitor as in A) above is electrically connected to the anode plate 11 of the capacitor layer 10. Each through-hole conductor 18 for the cathode of the capacitor or for ground connection as in B) above is electrically connected to the cathode layer 15 of the capacitor layer 10. Each through-hole conductor 18 for the I/O line as in C) above is not electrically connected to the anode plate 11 nor to the cathode layer 15 of the capacitor layer 10.

The through-hole conductor 18 for the anode of the capacitor as in A) above is formed in the through-hole piercing through the capacitor layer 10 with or without an insulating material filling the gap between the through-hole and the through-hole conductor 18. If the insulating material is not present, the through-hole conductor 18 is directly connected to the anode plate 11. The through-hole conductor 18 for the cathode of the capacitor or for ground connection as in B) above and the through-hole conductor 18 for the I/O line as in C) above are formed in the through-hole with the insulating material filling the gap between the through-hole conductor 18 and the through-hole piercing through the capacitor layer 10.

For example, the first through-hole conductor 18A can be used as the through-hole conductor 18 for the anode of the capacitor as in A) above, while the second through-hole conductor 18B can be used as the through-hole conductor 18 for the cathode of the capacitor or for ground connection as in B) above.

In the case of the solid electrolytic capacitor 1 including the sealing layer 20 as illustrated in FIGS. 1, 2, and 3, the sealing layer 20 is formed so as to cover the insulating layer 14 and the cathode layer 15. The sealing layer 20 may be disposed so as to cover both principal surfaces of the capacitor layer 10 or may be disposed so as to cover one of the principal surfaces.

In the case of the solid electrolytic capacitor 1 including the sealing layer 20, the material of the sealing layer 20 may fill the first piercing section 17A. In the case where the anode plate 11 is separated between the first cathode portion 16A and the second cathode portion 16B by the first piercing section 17A piercing through the anode plate 11 in the thickness direction as illustrated in FIG. 2, the material of the sealing layer 20 may fill the first piercing section 17A between the anode plate 11 for the first cathode portion 16A and the anode plate 11 for the second cathode portion 16B. The sealing layer 20 reliably separates the anode plate 11 for the first cathode portion 16A from the anode plate 11 for the second cathode portion 16B.

In the case of the second through-hole conductor 18B being formed inside the second through-hole 17Bb as illustrated in FIG. 3, the sealing layer 20 may be formed between the second through-hole conductor 18B and the anode plate 11. The sealing layer 20 reliably insulates the second through-hole conductor 18B from the anode plate 11 at the wall of the second through-hole 17Bb.

The sealing layer 20 is preferably made of a resin. Examples of the resin for the sealing layer 20 include epoxy resin and phenol resin. In addition, the sealing layer 20 preferably contain filler. For example, the sealing layer 20 contains an inorganic filler, such as silica particles, alumina particles, or metallic particles.

The sealing layer 20 may include only one layer or may include two layers or more. In the case of the sealing layer 20 including two layers or more, the materials of the two layers or more may be the same or may be different.

For example, a stress relaxation layer and a moisture-proof film may be formed between sealing layer 20 and the capacitor layer 10.

For example, in the case of the solid electrolytic capacitor 1 including the stress relaxation layer, the material of the stress relaxation layer may fill the first piercing section 17A. In the case where the anode plate 11 is separated between the first cathode portion 16A and the second cathode portion 16B by the first piercing section 17A piercing through the anode plate 11 in the thickness direction as illustrated in FIG. 2, the material of the stress relaxation layer may fill the first piercing section 17A between the anode plate 11 for the first cathode portion 16A and the anode plate 11 for the second cathode portion 16B.

The stress relaxation layer is preferably made of an insulating resin. Examples of the insulating resin for the stress relaxation layer include epoxy resin, phenol resin, and silicone resin. The stress relaxation layer preferably contains filler. For example, the stress relaxation layer contains an inorganic filler, such as silica particles, alumina particles, or metallic particles. The insulating resin of the stress relaxation layer is preferably different from the resin of the sealing layer 20.

The sealing layer 20 serves as an armor body that is required to have characteristics, for example, of close contact with outer electrodes. Accordingly, it may be difficult in general to select a resin having the coefficient of linear expansion that matches the capacitor layer 10 or having an appropriate modulus of elasticity. Providing the stress relaxation layer, however, enables appropriate adjustment of thermal stress without sacrificing the functions of the capacitor layer 10 and the sealing layer 20.

The stress relaxation layer is preferably lower in moisture permeability than the sealing layer 20. In this case, the stress relaxation layer can reduce the amount of moisture entering the capacitor layer 10 in addition to the adjustment of stress. The moisture permeability of the stress relaxation layer can be adjusted by changing the type of the insulating resin contained in the stress relaxation layer or the amount of the filler contained therein.

FIG. 7 is a cross-sectional view schematically illustrating a first through-hole conductor and the vicinity thereof according to another example of the solid electrolytic capacitor of the present invention.

In a solid electrolytic capacitor 1A illustrated in FIG. 7, the first through-hole conductor 18A is formed so as to pierce through the capacitor layer 10 in the thickness direction. More specifically, the first through-hole conductor 18A is formed at least on the wall surface of the first through-hole 17Ba that pierces through the capacitor layer 10 in the thickness direction. In the example illustrated in FIG. 7, the sealing layer 20 includes a first sealing layer 20A formed on the surface of the capacitor layer 10 and a second sealing layer 20B formed on the surface of the first sealing layer 20A.

As illustrated in FIG. 7, the first through-hole conductor 18A is preferably connected electrically to an end surface of the anode plate 11.

As illustrated in FIG. 7, the porous layer 12 is preferably exposed at the end surface of the anode plate 11 to be electrically connected to the first through-hole conductor 18A. This increase the contact area between the first through-hole conductor 18A and the porous layer 12, which improves the adhesion therebetween and reduces the occurrence of a problem, such as coming off of the first through-hole conductor 18A.

As illustrated in FIG. 7, the second insulating layer 14B is formed around the first through-hole conductor 18A in such a manner that an insulating material fills part of the porous layer 12 exposed at the end surface of the anode plate 11 to be electrically connected to the first through-hole conductor 18A. The insulating material, which fills a certain region of the porous layer 12 that surrounds the first through-hole conductor 18A, ensures the insulation between the anode plate 11 and the cathode layer 15 and thereby prevents short-circuiting. In addition, this can reduce the dissolution of the anode plate 11 at the end surface during chemical treatment for forming a conductor portion 30 (to be described later) or the like. The chemical solution can be prevented from entering the capacitor layer 10, which improves the reliability of the capacitor.

The second insulating layer 14B is formed such that the material of the second insulating layer 14B fills a portion of the porous layer 12 and that the second insulating layer 14B is also present on the surface of the filled portion of the porous layer 12. As such, the thickness of the second insulating layer 14B is preferably greater than that of the porous layer 12.

The first through-hole conductor 18A can be formed, for example, as follows. The first through-hole 17Ba is first formed by drilling or using laser or the like at a position where the first through-hole conductor 18A is planned. The first through-hole conductor 18A is subsequently formed by metallizing the wall surface of the first through-hole 17Ba with a low-resistance metal, such as copper, gold, or silver. When the first through-hole conductor 18A is formed, the wall surface of the first through-hole 17Ba can be metallized, for example, using electroless copper plating or electrolytic copper plating from the viewpoint of easy processing. In place of metallizing the wall surface of the first through-hole 17Ba, the formation of the first through-hole conductor 18A may be carried out, for example, by filling the first through-hole 17Ba with a metal or a composite material of a metal and a resin.

As illustrated in FIG. 7, an anode-connection layer 19 is preferably formed between the first through-hole conductor 18A and the end surface of the anode plate 11, and the first through-hole conductor 18A is preferably connected electrically to the end surface of the anode plate 11 via the anode-connection layer 19. The anode-connection layer 19, which is formed between the first through-hole conductor 18A and the end surface of the anode plate 11, serves as a barrier layer for the anode plate 11 and the porous layer 12. This can reduce the dissolution of the anode plate 11 during chemical treatment for forming a conductor portion 30 or the like (to be described later). The chemical solution can be prevented from entering the capacitor layer 10, which improves the reliability of the capacitor.

In the case of the anode-connection layer 19 being formed between the first through-hole conductor 18A and the end surface of the anode plate 11, for example, the anode-connection layer 19 includes, in the order from the anode plate 11, a first anode-connection layer 19A containing zinc as a main ingredient and a second anode-connection layer 19B containing nickel or copper as a main ingredient as illustrate in FIG. 7. For example, the first anode-connection layer 19A is formed by precipitating zinc on the end surface of the anode plate 11 using zincate treatment. Subsequently, the second anode-connection layer 19B is formed on the first anode-connection layer 19A using electroless nickel plating or electroless copper plating. Note that the first anode-connection layer 19A may disappear and, in such a case, the anode-connection layer 19 may include only the second anode-connection layer 19B.

The anode-connection layer 19 preferably includes a layer containing nickel as a main ingredient. Presence of nickel in the anode-connection layer 19 can reduce the negative impact on the metal contained in the anode plate 11, such as aluminum, which improves performance as the barrier.

In the case of the anode-connection layer 19 being formed between the first through-hole conductor 18A and the end surface of the anode plate 11, the dimension of the anode-connection layer 19 in the thickness direction of the anode plate 11 is preferably greater than the dimension of the anode plate 11 in the thickness direction thereof. In such a case, the anode-connection layer 19 can entirely cover the end surfaces of the anode plate 11 and the porous layer 12, which further reduces the occurrence of the above-described dissolution of the anode plate 11.

In the thickness direction of the anode plate 11, the ratio of the dimension of the anode-connection layer 19 to the dimension of the anode plate 11 is greater than 100% and smaller than or equal to 200%. In the thickness direction of the anode plate 11, the dimension of the anode-connection layer 19 may be equal to or, may be smaller than, the dimension of the anode plate 11.

The anode-connection layer 19 does not need to be formed between the first through-hole conductor 18A and the end surface of the anode plate 11. In such a case, the first through-hole conductor 18A is directly connected to the end surface of the anode plate 11.

As illustrated in FIG. 1, the first through-hole conductor 18A is preferably connected electrically to the end surface of the anode plate 11 along the entire circumference of the first through-hole 17Ba. This increases the contact area between the first through-hole conductor 18A and the anode plate 11 and thereby decreases the connection resistance therebetween, thereby decreasing the equivalent series resistance (ESR) of the capacitor. This also improves the adhesion between the first through-hole conductor 18A and the anode plate 11, which reduces the occurrence of a problem, such as coming off of the first through-hole conductor 18A caused by heat stress.

It is preferable that a material containing resin be filled inside the first through-hole 17Ba. More specifically, as illustrated in FIG. 7, a first resin-filled portion 21A is preferably formed inside the first through-hole 17Ba. Filling the void with a resin material inside the first through-hole 17Ba can reduces the occurrence of delamination of the first through-hole conductor 18A formed on the wall surface of the first through-hole 17Ba.

The material to be filled in the first through-hole 17Ba preferably has a coefficient of thermal expansion greater than that of the material (for example, copper) of the first through-hole conductor 18A. In such a case, the material filled in the first through-hole 17Ba expands under a high-temperature environment and presses the first through-hole conductor 18A outward against the wall of the first through-hole 17Ba, which further reduces the occurrence of delamination of the first through-hole conductor 18A.

The coefficient of thermal expansion of the material filled in the first through-hole 17Ba may be the same as, or may be smaller than, that of the material of the first through-hole conductor 18A.

The first through-hole 17Ba does not need to have the material containing resin to be filled therein. In such a case, it is preferable that the first through-hole conductor 18A be preferably not only formed on the wall surface of the first through-hole 17Ba but also formed so as to fill the first through-hole 17Ba entirely.

It is preferable that as illustrated in FIG. 7, the solid electrolytic capacitor 1A further include a conductor portion 30 that is electrically connected to the first through-hole conductor 18A. In the example illustrated in FIG. 7, a conductor portion 30 is formed on a surface of the first through-hole conductor 18A. The conductor portion 30 can function as a connection terminal of the solid electrolytic capacitor 1A (the capacitor layer 10).

For example, the material of the conductor portion 30 is a low-resistance metal, such as silver, gold, and copper. In such a case, the conductor portion 30 is formed by plating on the surface of the first through-hole conductor 18A.

In order to improve the adhesion between the conductor portion 30 and another member, in other words, the first through-hole conductor 18A in this case, a mixture of a resin and a conductive filler may be used as the material of the conductor portion 30. The conductive filler is made of at least one selected from the group consisting of silver filler, copper filler, nickel filler, and carbon filler.

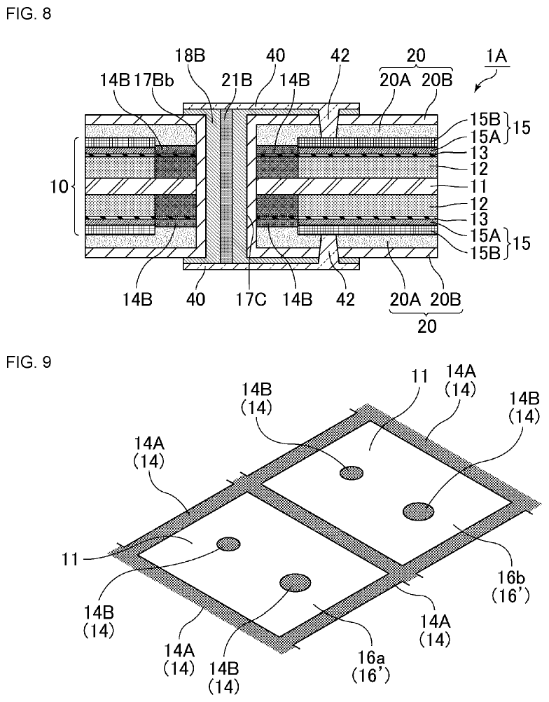

FIG. 8 is a cross-sectional view schematically illustrating a second through-hole conductor and its vicinity of the solid electrolytic capacitor of FIG. 7.

In the solid electrolytic capacitor 1A of FIG. 8, the second through-hole conductor 18B is formed so as to pierce through the capacitor layer 10 in the thickness direction. More specifically, the second through-hole conductor 18B is formed on the wall surface of the third through-hole 17C that pierces through the capacitor layer 10 in the thickness direction. In the example illustrated in FIG. 8, the sealing layer 20 includes the first sealing layer 20A formed on the surface of the capacitor layer 10 and the second sealing layer 20B formed on the surface of the first sealing layer 20A.

As illustrated in FIG. 8, the second through-hole conductor 18B is preferably connected electrically to the cathode layer 15. In the example illustrated in FIG. 8, a conductor portion 40 is formed on a surface of the second through-hole conductor 18B. The conductor portion 40 can function as a connection terminal of the solid electrolytic capacitor 1A (the capacitor layer 10). In the example illustrated in FIG. 8, a via conductor 42 is also formed so as to pierce through the sealing layer 20 in the thickness direction and connect the conductor portion 40 to the cathode layer 15. Accordingly, in the example illustrated in FIG. 8, the second through-hole conductor 18B is electrically connected to the cathode layer 15 via the conductor portion 40 and the via conductor 42. This configuration leads to size reduction of the solid electrolytic capacitor LA.

The second through-hole conductor 18B is formed, for example, as follows. The second through-hole 17Bb is first formed by drilling or using laser or the like at a position where the second through-hole conductor 18B is planned. An insulating layer is subsequently formed in the second through-hole 17Bb by filling the second through-hole 17Bb with the material of the second sealing layer 20B (for example, a resin material). The third through-hole 17C is formed in the above insulating layer by drilling or using laser or the like. Here, the hole diameter of the third through-hole 17C is set to be smaller than that of the second through-hole 17Bb, which leaves the material of the second sealing layer 20B between the wall of the second through-hole 17Bb and the third through-hole 17C. The second through-hole conductor 18B is formed by metallizing the wall surface of the third through-hole 17C with a low-resistance metal, such as copper, gold, or silver. When the second through-hole conductor 18B is formed, the wall surface of the third through-hole 17C can be metallized, for example, using electroless copper plating or electrolytic copper plating from the viewpoint of easy processing. In place of metallizing the wall surface of the third through-hole 17C, the formation of the second through-hole conductor 18B may be carried out, for example, by filling the third through-hole 17C with a metal or a composite material of a metal and a resin.

For example, the material of the conductor portion 40 is a low-resistance metal, such as silver, gold, and copper. In such a case, the conductor portion 40 is formed by plating the surface of the second through-hole conductor 18B.

In order to improve the adhesion between the conductor portion 40 and another member, in other words, the second through-hole conductor 18B in this case, a mixture of a resin and a conductive filler may be used as the material of the conductor portion 40. The conductive filler is made of at least one selected from the group consisting of silver filler, copper filler, nickel filler, and carbon filler.

For example, the via conductor 42 is made of the same material as that of the conductor portion 40.

The via conductor 42 is formed by plating the wall surface of a through-hole that pierces through the sealing layer 20 in the thickness direction or by filling the through-hole with a conductive paste and heating the conductive paste.

It is preferable that a material containing resin be filled inside the third through-hole 17C. More specifically, as illustrated in FIG. 8, a second resin-filled portion 21B is preferably formed inside the third through-hole 17C. Filling the void with the resin material inside the third through-hole 17C can reduces the occurrence of delamination of the second through-hole conductor 18B formed on the wall surface of the third through-hole 17C.

The material to be filled in the third through-hole 17C preferably has a coefficient of thermal expansion greater than that of the material (for example, copper) of the second through-hole conductor 18B. In such a case, the material filled in the third through-hole 17C expands under a high-temperature environment and presses the second through-hole conductor 18B outward against the wall of the third through-hole 17C, which further reduces the occurrence of delamination of the second through-hole conductor 18B.

The coefficient of thermal expansion of the material filled in the third through-hole 17C may be the same as, or may be smaller than, that of the material of the second through-hole conductor 18B.

The material containing resin need not be present in the third through-hole 17C. In such a case, it is preferable that the second through-hole conductor 18B be not only formed on the wall surface of the third through-hole 17C but also formed so as to fill the third through-hole 17C entirely.

In the case of the sealing layer 20 including the first sealing layer 20A and the second sealing layer 20B, the second sealing layer 20B is preferably present between the second through-hole conductor 18B and the anode plate 11 as illustrated in FIG. 8. The second sealing layer 20B between the second through-hole conductor 18B and the anode plate 11 can insulate the anode plate 11 from the second through-hole conductor 18B.

In the case of the second sealing layer 20B being present between the second through-hole conductor 18B and the anode plate 11 as illustrated in FIG. 8, the porous layer 12 is preferably exposed at the end surface of the anode plate 11 being in contact with the second sealing layer 20B. This increases the contact area between the second sealing layer 20B and the porous layer 12, which improves the adhesion therebetween and reduces the occurrence of a problem, such as coming off of the second sealing layer 20B.

As illustrated in FIG. 8, the second insulating layer 14B is formed around the second through-hole conductor 18B in such a manner that the insulating material fills part of the porous layer 12 exposed at the end surface of the anode plate 11 being in contact with the second sealing layer 20B. The insulating material, which fills a certain region of the porous layer 12 that surrounds the second through-hole conductor 18B, ensures the insulation between the anode plate 11 and the second through-hole conductor 18B and thereby prevents short-circuiting.

The second insulating layer 14B is formed such that the material of the second insulating layer 14B fills a portion of the porous layer 12 and that the second insulating layer 14B is also present on the surface of the filled portion of the porous layer 12. As such, the thickness of the second insulating layer 14B is preferably greater than that of the porous layer 12.

In the case of the second sealing layer 20B being present between the second through-hole conductor 18B and the anode plate 11, the insulating material for forming the second sealing layer 20B fills part of the void in the porous layer 12. This can improve the mechanical strength of the porous layer 12. This can also suppress the occurrence of delamination due to the presence of void in the porous layer 12.

The insulating material of the second sealing layer 20B preferably has a coefficient of thermal expansion greater than that of the material (for example, copper) of the second through-hole conductor 18B. In such a case, the insulating material of the second sealing layer 20B expands under a high-temperature environment and presses the porous layer 12 and the second through-hole conductor 18B, which further reduces the occurrence of the delamination.

The coefficient of thermal expansion of the material of the second sealing layer 20B may be the same as, or may be smaller than, that of the material of the second through-hole conductor 18B.

Method of Manufacturing Solid Electrolytic Capacitor

The method of manufacturing the solid electrolytic capacitor of the present invention includes a step of forming an insulating layer on an anode plate, a step of forming a cathode layer, and a step of forming a first piercing section.

An example of the method of manufacturing the solid electrolytic capacitor 1 of FIG. 1 will be described with reference to the drawings.

FIG. 9 is a perspective view schematically illustrating an example of the step of forming the insulating layer on the anode plate.

The anode plate 11 made of a valve metal is prepared first. The porous layer 12 (see FIG. 5) is formed on at least one of the principal surfaces of the anode plate 11, and the dielectric layer 13 (see FIG. 5) is also formed on the surface of the porous layer 12, which are not illustrated in FIG. 9.

For example, the dielectric layer 13 is formed on the surface of the porous layer 12 in such a manner that the anodic oxidation treatment is performed onto the anode plate 11 of which at least one of the principal surfaces has the porous layer 12 formed thereon.

Alternatively, a surface-treated foil using chemical conversion may be provided as the anode plate 11 having the dielectric layer 13 formed on the surface of the porous layer 12.

Subsequently, the insulating layer 14 is formed such that the material of the insulating layer 14 fills a portion of the porous layer 12 and that the insulating layer 14 is also present on the surface of the filled portion of the porous layer 12.

The step of forming the insulating layer 14 includes a step of forming the first insulating layer 14A that divides the anode plate 11 into two or more element regions 16′ and that surrounds at least one of the element regions 16′ as viewed in the thickness direction. FIG. 9 illustrates an adjacent pair of the element regions 16′, in other words, a first element region 16a and a second element region 16b. The first insulating layer 14A is formed so as to surround the first element region 16a and the second element region 16b.

The step of forming the insulating layer 14 may also include a step of forming the second insulating layer 14B within each element region 16′ surrounded by the first insulating layer 14A. In such a case, the second insulating layer 14B may be formed within at least one of the element regions 16′. In FIG. 9, the second insulating layer 14B is formed in each of the first element region 16a and the second element region 16b.

The insulating layer 14, which includes the first insulating layer 14A and the second insulating layer 14B, is preferably formed by applying a solution or a dispersion containing an insulating resin (hereinafter referred to as an “insulating ink”) on the surface of the porous layer 12 by using an applicator or by transferring or printing. The insulating layer 14 can be formed inside the porous layer 12 and also on the surface of the permeated portion of the porous layer 12 by allowing the insulating ink to permeate the porous layer 12.

In the step of forming the insulating layer 14, it is preferable that the surface tension of the insulating ink be 20 mN/m to 50 mN/m, the static contact angle between the insulating ink and the porous layer be 50° to 90°, and the viscosity of the insulating ink be 1.5 Pa·s to 25 Pa·s.

The permeation of the insulating ink into the porous layer 12 formed in the anode plate 11 can be explained in general using the Lucas-Washburn equation.

L=(r×γ×t×cos θ/2η)^{1/2}
(where L is penetration depth, r is pore radius, γ is surface tension, η is viscosity, θ is contact angle, and t is time for permeation)

Assume that the pore radius r, which depends on the pore size of the porous layer 12 formed in the anode plate 11, and the time t, which depends on the method of ink application, are constant. In this case, the penetration depth L of the insulating ink into the porous layer 12 formed in the anode plate 11 can be considered to be dominated by the surface tension γ of the insulating ink, the contact angle θ between the insulating ink and the porous layer, and the viscosity η of the insulating ink.

The permeation of the insulating ink into the porous layer 12 can be controlled by setting the surface tension of the insulating ink to be 20 mN/m to 50 mN/m, the static contact angle between the insulating ink and the porous layer to be 50° to 90°, and the viscosity of the insulating ink to be 1.5 Pa·s to 25 Pa·s. As a result, the insulating ink can penetrate a necessary region in the porous layer 12, while the insulating ink does not penetrate an unnecessary region in the porous layer 12 easily. More specifically, the insulating ink can penetrate a portion of the porous layer 12 vertically in the thickness direction from the area to which the insulating ink is applied. In other words, the insulating layer 14 can be formed so as to extend vertically in the thickness direction from the area to which the insulating ink is applied. This can reduce the variation in the electrostatic capacity expected from the projected area surrounded by the insulating ink in the solid electrolytic capacitor to be obtained.

The surface tension of the insulating ink and the static contact angle between the insulating ink and the porous layer are measured at 25° C. using an interfacial tensiometer (for example, an automatic interfacial tensiometer PD-W manufactured by Kyowa Interface Science Co., Ltd.).

The viscosity of the insulating ink is measured at 25° C. using a rotational viscometer. More specifically, the viscosity of the insulating ink is measured at a speed of 10 rpm using an E-type viscometer.

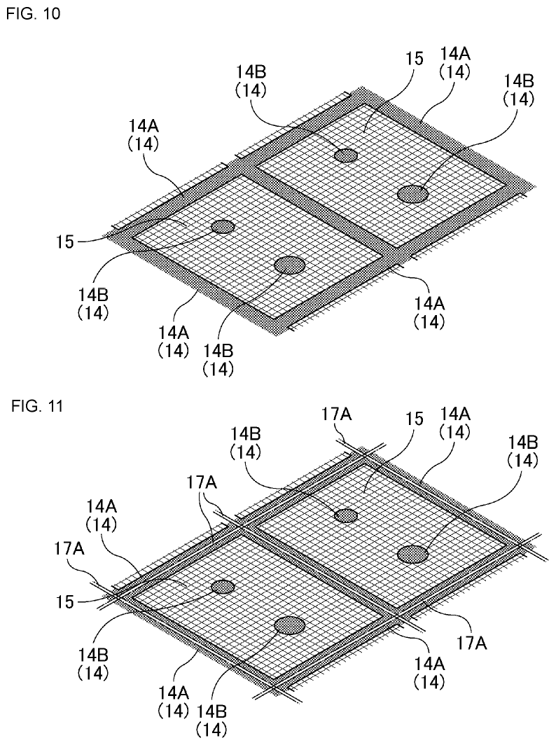

FIG. 10 is a perspective view schematically illustrating an example of the step of forming the cathode layer.

The cathode layer 15 is formed on the surface of the dielectric layer 13. The cathode layer 15 is formed in each element region 16′. Accordingly, the cathode layer 15 is divided into two or more cathode portions 16 (for example, see FIG. 4).

The cathode layer 15 includes the solid electrolyte layer 15A (for example, see FIG. 5) formed on the surface of the dielectric layer 13 within each element region 16′. It is preferable that the cathode layer 15 also include the conductive layer 15B (for example, see FIG. 5) formed on the surface of the solid electrolyte layer 15A.

As a result, the capacitor layer 10 is formed as illustrated in FIGS. 4, 5, and 6. The capacitor layer 10 includes the anode plate 11, the porous layer 12, the dielectric layer 13, the insulating layer 14, and the cathode layer 15. The porous layer 12 is formed on at least one of the principal surfaces of the anode plate 11. The dielectric layer 13 is formed on the surface of the porous layer 12. The insulating layer 14 is formed such that the material of the insulating layer 14 fills a portion of the porous layer 12 and that the insulating layer 14 is also present on the surface of the filled portion of the porous layer 12. The cathode layer 15 is formed on the surface of the dielectric layer 13.

FIG. 11 is a perspective view schematically illustrating an example of the step of forming the first piercing section.

The first piercing section 17A is formed so as to pierce through both of the porous layer 12 and the first insulating layer 14A in the thickness direction. The first piercing section 17A may also pierce through the anode plate 11 in the thickness direction. In other words, the first piercing section 17A may pierce through the capacitor layer 10 in the thickness direction.

For example, the first piercing section 17A can be formed using laser or using a dicing machine.

The anode plate 11 may be separated between at least one adjacent pair of the cathode portions 16, in other words, between the first cathode portion 16A and the second cathode portion 16B. More specifically, the anode plate 11 may be separated physically, or may be separated electrically, between at least one adjacent pair of the cathode portions 16, in other words, between the first cathode portion 16A and the second cathode portion 16B. For example, the anode plate 11 may be separated between the first cathode portion 16A and the second cathode portion 16B in such a manner that the first piercing section 17A pierces through the anode plate 11 in the thickness direction.

In the case of the step of forming the insulating layer including a step of forming the second insulating layer, the method of manufacturing the solid electrolytic capacitor of the present invention may include a step of forming the second piercing section.

When each second insulating layer 14B, which is included in the insulating layer 14, is formed as illustrated in FIG. 9, the second piercing section 17B may be formed so as to pierce through both of the porous layer 12 and the second insulating layers 14B in the thickness direction (for example, see FIG. 4). The second piercing section 17B may pierce through the anode plate 11 in the thickness direction. In other words, the second piercing section 17B may pierce through the capacitor layer 10 in the thickness direction.

For example, the second piercing section 17B can be formed by using laser or by drilling.

The step of forming the second piercing section may include a step of forming the first through-hole and a step of forming the second through-hole having a diameter greater than that of the first through-hole.

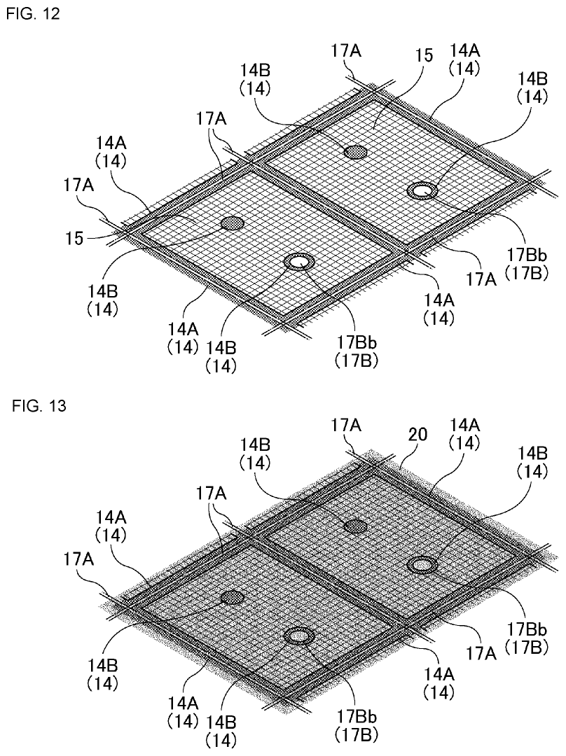

FIG. 12 is a perspective view schematically illustrating an example of the step of forming second through-holes, which is part of the step of forming the second piercing section.

In FIG. 12, the second through-holes 17Bb are formed as part of the second piercing section 17B.

The method of manufacturing the solid electrolytic capacitor of the present invention may further include a step of forming a sealing layer so as to cover the insulating layer and the cathode layer.

FIG. 13 is a perspective view schematically illustrating an example of the step of forming the sealing layer.

For example, the sealing layer 20 is formed by press-forming an insulating material so as to cover both or one of the principal surfaces of the capacitor layer 10.

When the sealing layer 20 is formed, the material of the sealing layer 20 may fill the first piercing section 17A as illustrated in FIG. 13. In the case where the anode plate 11 is separated between the first cathode portion 16A and the second cathode portion 16B by the first piercing section 17A that pierces through the anode plate 11 in the thickness direction, the material of the sealing layer 20 may fill the first piercing section 17A between the anode plate 11 for the first cathode portion 16A and the anode plate 11 for the second cathode portion 16B. The sealing layer 20 reliably separates the anode plate 11 for the first cathode portion 16A from the anode plate 11 for the second cathode portion 16B.

In the case of the second through-holes 17Bb being formed, the material of the sealing layer 20 may fill the second through-holes 17Bb as illustrated in FIG. 13.

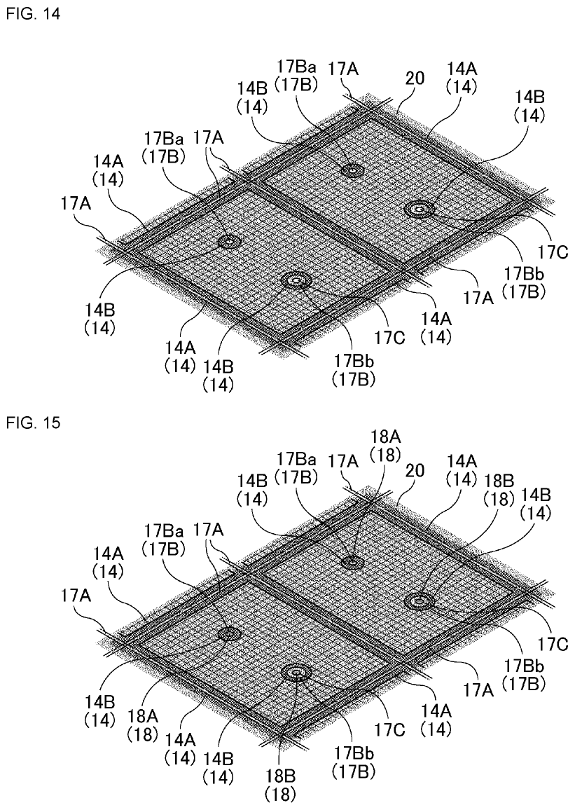

FIG. 14 is a perspective view schematically illustrating an example of a step of forming first through-holes, which is part of the step of forming the second piercing section.

In FIG. 14, the first through-holes 17Ba having diameters smaller than the second through-holes 17Bb are formed as part of the second piercing section 17B. In FIG. 14, the third through-holes 17C having diameters smaller than the second through-hole 17Bb are further formed. The diameter of each third through-hole 17C may be the same as, or smaller or larger than, the diameter of the first through-hole 17Ba.

The method of manufacturing the solid electrolytic capacitor of the present invention preferably includes a step of forming through-hole conductors that extend in the thickness direction inside the second piercing section.

FIG. 15 is a perspective view schematically illustrating an example of a step of forming through-hole conductors.

As illustrated in FIG. 15, the through-hole conductor 18 is preferably formed inside the second piercing section 17B so as to extend in the thickness direction. In such a case, the through-hole conductor 18 is preferably formed so as to pierce through the capacitor layer 10 and the sealing layer 20 in the thickness direction.

The first through-hole conductor 18A is formed inside the first through-hole 17Ba so as to extend in the thickness direction. The first through-hole conductor 18A is preferably formed so as to pierce through the capacitor layer 10 and the sealing layer 20 in the thickness direction. The first through-hole conductor 18A is preferably connected electrically to the anode plate 11 at the wall of the first through-hole 17Ba. In FIG. 15, the first through-hole conductor 18A is formed so as to fill each first through-hole 17Ba. It is sufficient, however, that the first through-hole conductor 18A is formed at least on the wall surface of each first through-hole 17Ba.

The second through-hole conductor 18B is formed inside each second through-hole 17Bb so as to extend in the thickness direction. The second through-hole conductor 18B is preferably formed so as to pierce through the capacitor layer 10 and the sealing layer 20 in the thickness direction. The second through-hole conductor 18B is preferably insulated electrically from the anode plate 11 at the wall of the second through-hole 17Bb. In FIG. 15, the second through-hole conductor 18B is formed so as to fill the third through-hole 17C. It is sufficient, however, that the second through-hole conductor 18B is formed at least on the wall surface of the third through-hole 17C.

In the case of the second through-hole conductor 18B being formed inside the second through-hole 17Bb as illustrated in FIG. 15, the sealing layer 20 may be formed between the second through-hole conductor 18B and the anode plate 11. The sealing layer 20 reliably insulates the second through-hole conductor 18B from the anode plate 11 at the wall of the second through-hole 17Bb.

The solid electrolytic capacitor 1 of FIG. 1 can be manufactured according to the method described above.

As described above, when the solid electrolytic capacitor of the present invention is manufactured, the first piercing section can be formed, for example, using laser or a dicing machine.

Using laser enables the cathode portion to be shaped freely. Using laser enables the solid electrolytic capacitor to have various configurations. For example, two or more types of capacitor layers with cathode portions having different areas can be formed in a single solid electrolytic capacitor. The first piercing section can be formed so as not to overlap the entire solid electrolytic capacitor. A capacitor layer of which the cathode portion is not shaped rectangularly as viewed in plan can be formed.

[Composite Electronic Component]

The solid electrolytic capacitor of the present invention can be used as an element of a composite electronic component. For example, such a composite electronic component includes the solid electrolytic capacitor of the present invention, outer electrodes, and another electronic component. The outer electrodes are disposed outside the solid electrolytic capacitor (preferably outside the sealing layer of the solid electrolytic capacitor). The outer electrodes are connected to the anode plate and the cathode layer of the solid electrolytic capacitor, and the electronic component is connected to the outer electrodes.

In the composite electronic component, the electronic component connected to the outer electrodes may be a passive element or an active element. Both passive element and active element may be connected to the outer electrodes, or either one of the passive and active elements may be connected to the outer electrodes. A composite component formed of the passive element and the active element may be connected to the outer electrodes.

An example of the passive element is an inductor. Examples of the active element include a memory, a graphical processing unit (GPU), a central processing unit (CPU), a micro processing unit (MPU), and a power management IC (PMIC).

The solid electrolytic capacitor of the present invention is shaped like a sheet as a whole. Accordingly, the solid electrolytic capacitor can serve as a circuit substrate in the composite electronic component, and other electronic components can be mounted on the solid electrolytic capacitor. Electronic components to be mounted on the solid electrolytic capacitor may be also shaped like sheets. Accordingly, the solid electrolytic capacitor and the electronic components can be connected to each other using through-hole conductors piercing through each electronic component in the thickness direction. Accordingly, the active element and the passive element can be integrated in a module.

For example, a switching regulator can be formed by electrically connecting the solid electrolytic capacitor of the present invention between a voltage regulator having a semiconductor active element and a load to which a converted direct current is supplied.

In the composite electronic component, multiple solid electrolytic capacitors of the present invention may be arrayed on a capacitor matrix sheet. A circuit layer may be formed on one side of the matrix sheet, and the passive or active element may be connected to the capacitor matrix sheet.

The solid electrolytic capacitor of the present invention may be disposed in a cavity formed in a substrate, the cavity may be covered with resin, and a circuit layer may be formed thereon. Another electronic component (a passive or active element) may be disposed in another cavity formed in the same substrate.

Alternatively, the solid electrolytic capacitor of the present invention may be mounted on a flat carrier, such as a wafer or a glass plate. The flat carrier is covered with resin, a circuit layer is formed thereon, and the flat carrier is connected to a passive or active element.

### Example

The following describes an example in which the solid electrolytic capacitor of the present invention and the method of manufacturing the solid electrolytic capacitor are disclosed more specifically. Note that the example described below is not intended to limit the present invention.

Preparation of Capacitor Element

A surface-treated (surface-etched) aluminum foil was prepared to serve as the anode plate.

The insulating layer was formed on the anode plate so as to define a rectangular element region using an insulating ink with physical properties summarized in Table 1. Depending on the viscosity, the insulating ink was applied so as to form a pattern that surrounds the element region by printing in the case of a high-viscosity ink or by transferring or using an applicator in the case of a low-viscosity ink. The insulating layer was formed by curing and drying the insulating ink.

The solid electrolyte layer was formed in the element region. A dispersion liquid of poly(3,4-ethylenedioxythiophene), which is an electroconductive polymer, was used as a processing liquid containing a solid electrolyte. After the solid electrolyte layer was formed, the carbon layer and the copper layer were formed thereon.

The capacitor element was prepared through the above steps. Capacitor elements of ten different levels per each condition were prepared.

Evaluation of Capacitor Element

(External Appearance after Application)

The insulating layer needs to have a certain height when forming the cathode layer using a dipping method or a printing method after the insulating layer is formed. For this purpose, whether the insulating layer remained on the surface of the porous layer was observed. From the observation of the cross section of each capacitor element, the sample was evaluated as “poor” if the insulating layer did not remain on the surface of the porous layer, evaluated as “reasonable” if the height of the insulating layer from the surface of the porous layer was greater than 0 μm and smaller than 5 μm, and evaluated as “good” if the height of the insulating layer from the surface of the porous layer was 5 μm or more. The results are collated in Table 1.

(Penetration into Porous Layer)

In order to determine whether the insulating ink permeates the required region of the porous layer, the cross section of the capacitor element was observed to check if the insulating layer was formed so as to extend vertically in the thickness direction from the area to which the insulating ink was applied. More specifically, the insulating layer was confirmed using the elemental mapping image of carbon, and the solid electrolyte layer was confirmed using the elemental mapping image of sulfur. The sample in which the insulating layer was not formed vertically was evaluated as “poor”, and the sample in which the insulating layer was formed vertically was evaluated as “good” The results are collated in Table 1.

(Deviation from Design Electrostatic Capacity)

In order to determine whether the penetration of the insulating ink was controlled appropriately, the variation of the electrostatic capacity relative to that expected from the projected area defined by the insulating ink was measured. If the variation of the electrostatic capacity was great, the formation of the insulating layer can be regarded as varying greatly. The results are collated in Table 1.

TABLE 1

| | Insulating ink | | | Evaluation | | |
|---|---|---|---|---|---|---|
| | | Static | | | | Deviation |
| | | contact | | | | from |
| | | angle | | | | design |
| | Surface | from | | External | Penetration | electro- |
| | tension | base | | appearance | into | static |
| | (mN/ | material | Viscosity | after | porous | capacity |
| Sample | m) | (°) | (Pa · s) | application | layer | (%) |
| 1 | 42 | 32 | 4.2 | poor | good | — |
| 2 | 40 | 40 | 4.5 | poor | good | — |
| 3 | 39 | 44 | 2.5 | poor | good | — |
| 4 | 21 | 60 | 3.2 | good | good | ±10% |
| 5 | 23 | 60 | 2.9 | good | good | ±10% |
| 6 | 25 | 60 | 12 | good | good | ±5% |
| 7 | 22 | 63 | 1.5 | good | good | ±10% |
| 8 | 22 | 63 | 6 | good | good | ±10% |
| 9 | 25 | 65 | 20 | good | good | ±10% |
| 10 | 25 | 68 | 30 | good | poor | ±15% |
| 11 | 41 | 69 | 5.1 | good | good | ±10% |
| 12 | 41 | 69 | 12.8 | good | good | ±10% |
| 13 | 20 | 75 | 1.8 | reasonable | good | ±15% |
| 14 | 55 | 100 | 15 | poor | poor | — |

In Samples 1 to 3 in which the static contact angle between the insulating ink and the porous layer was less than 50°, the insulating layer did not remain on the surface of the porous layer.

In Sample 10 in which the viscosity of the insulating ink was greater than 25 Pa·s, the insulating layer was not formed vertically in the thickness direction from the area to which the insulating ink was applied.

In Sample 14 in which the surface tension of the insulating ink was greater than 50 mN/m and the static contact angle between the insulating ink and the porous layer was greater than 90°, the insulating layer did not remain on the surface of the porous layer and the insulating layer was not formed vertically in the thickness direction from the area to which the insulating ink was applied.

On the other hand, in Samples 4 to 9 and 11 to 13, in which the surface tension of the insulating ink was 20 mN/m to 50 mN/m, the static contact angle between the insulating ink and the porous layer was 50° to 90°, and the viscosity of the insulating ink was 1.5 Pas to 25 Pa·s, the insulating layer remained on the surface of the porous layer and the insulating layer was formed vertically in the thickness direction from the area to which the insulating ink was applied.

### REFERENCE SIGNS LIST

1, 1A solid electrolytic capacitor
10 capacitor layer
11 anode plate
12 porous layer
13 dielectric layer
14 insulating layer
14A first insulating layer
14B second insulating layer
15 cathode layer
15A solid electrolyte layer
15B conductive layer
16 cathode portion
16A first cathode portion
16B second cathode portion
16′ element region
16a first element region
16b second element region
17A first piercing section
17B second piercing section
17Ba first through-hole
17Bb second through-hole
17C third through-hole
18 through-hole conductor
18A first through-hole conductor
18B second through-hole conductor
19 anode-connection layer
20 sealing layer
20A first sealing layer
20B second sealing layer
21A first resin-filled portion
21B second resin-filled portion
30, 40 conductor portion
42 via conductor

1. A solid electrolytic capacitor comprising:
an anode plate made of a valve metal;
a porous layer on at least one principal surface of the anode plate;
a dielectric layer on the porous layer;
a cathode layer including a solid electrolyte layer on the dielectric layer, the cathode layer including two or more cathode portions;
a first insulating layer that surrounds at least one of the cathode portions as viewed in a thickness direction of the solid electrolytic capacitor, wherein a material of the first insulating layer fills a portion of the porous layer and is also present on a surface of the filled portion of the porous layer; and
a first piercing section that pierces through both of the porous layer and the first insulating layer in the thickness direction.

2. The solid electrolytic capacitor according to claim 1, further comprising a second insulating layer within the cathode portion and surrounded by the first insulating layer.

3. The solid electrolytic capacitor according to claim 2, further comprising a second piercing section that pierces through both of the porous layer and the second insulating layer in the thickness direction.

4. The solid electrolytic capacitor according to claim 3, further comprising a through-hole conductor inside the second piercing section and that extends in the thickness direction.

5. The solid electrolytic capacitor according to claim 3, wherein
the second piercing section includes a first through-hole and a second through-hole, and
the second through-hole has a hole diameter larger than that of the first through-hole.

6. The solid electrolytic capacitor according to claim 5, further comprising:
a first through-hole conductor inside the first through-hole and that extends in the thickness direction, and
the first through-hole conductor is electrically connected to the anode plate at a wall of the first through-hole.

7. The solid electrolytic capacitor according to claim 5, further comprising:
a second through-hole conductor inside the second through-hole and that extends in the thickness direction, and
the second through-hole conductor is electrically insulated from the anode plate at a wall of the second through-hole.

8. The solid electrolytic capacitor according to claim 7, further comprising:
a sealing that covers the insulating layer and the cathode layer, and is also present between the second through-hole conductor and the anode plate.

9. The solid electrolytic capacitor according to claim 1, further comprising a sealing layer that covers the insulating layer and the cathode layer.

10. The solid electrolytic capacitor according to claim 1, wherein the anode plate is separated between at least one adjacent pair of the cathode portions, the at least one adjacent pair including a first cathode portion and a second cathode portion.

11. The solid electrolytic capacitor according to claim 10, wherein the anode plate is separated between the first cathode portion and the second cathode portion such that the first piercing section pierces through the anode plate in the thickness direction.

12. The solid electrolytic capacitor according to claim 11, wherein
the sealing layer covers the insulating layer and the cathode layer, and
the sealing layer is also present in the first piercing section at a position between the anode plate of the first cathode portion and the anode plate of the second cathode portion.

13. A method of manufacturing a solid electrolytic capacitor, the method comprising:
providing an anode plate made of a valve metal;
forming a porous layer on at least one principal surface of the anode plate;
forming a dielectric layer on the porous layer;
forming a cathode layer that includes a solid electrolyte layer formed on a surface of a dielectric layer;
dividing the cathode layer into two or more cathode portions;
forming a first insulating layer that divides the anode plate into two or more element regions and surrounds at least one of the element regions as viewed in a thickness direction of the anode plate, wherein each of the two or more element regions includes one of the two or more cathode portions, and a material of the insulating layer fills a portion of the porous layer and is also present on a surface of the filled portion of the porous layer; and
forming a first piercing section that pierces through both of the porous layer and the first insulating layer in the thickness direction.

14. The method of manufacturing the solid electrolytic capacitor according to claim 13, further comprising forming a second insulating layer within the element region surrounded by the first insulating layer.

15. The method of manufacturing the solid electrolytic capacitor according to claim 14, further comprising:
forming a second piercing section that pierces through both of the porous layer and the second insulating layer in the thickness direction.

16. The method of manufacturing the solid electrolytic capacitor according to claim 15, further comprising:
forming a through-hole conductor inside the second piercing section, the through-hole conductor extending in the thickness direction.

17. The method of manufacturing the solid electrolytic capacitor according to claim 15, wherein the forming of the second piercing section includes forming a first through-hole and forming a second through-hole having a hole diameter greater than that of the first through-hole.

18. The method of manufacturing the solid electrolytic capacitor according to claim 17, further comprising:
forming a first through-hole conductor inside the first through-hole, the first through-hole conductor extending in the thickness direction, wherein
the first through-hole conductor is electrically connected to the anode plate at a wall of the first through-hole.

19. The method of manufacturing the solid electrolytic capacitor according to claim 17, further comprising:
forming a second through-hole conductor inside the second through-hole, the second through-hole conductor extending in the thickness direction, wherein
the second through-hole conductor is electrically insulated from the anode plate at a wall of the second through-hole.

20. The method of manufacturing the solid electrolytic capacitor according to claim 19, further comprising:
forming a sealing layer that covers the insulating layer and the cathode layer, and is also present between the second through-hole conductor and the anode plate.

21. The method of manufacturing the solid electrolytic capacitor according to claim 13, further comprising:
forming a sealing layer that covers the insulating layer and the cathode layer.

22. The method of manufacturing the solid electrolytic capacitor according to claim 13, wherein the anode plate is separated between at least one adjacent pair of the two or more cathode portions, the at least one adjacent pair including a first cathode portion and a second cathode portion.

23. The method of manufacturing the solid electrolytic capacitor according to claim 22, wherein the anode plate is separated between the first cathode portion and the second cathode portion such that the first piercing section pierces through the anode plate in the thickness direction.

24. The method of manufacturing the solid electrolytic capacitor according to claim 23, further comprising:
forming a sealing layer that covers the insulating layer and the cathode layer, and is also present in the first piercing section at a position between the anode plate of the first cathode portion and the anode plate of the second cathode portion.
